(19) United States
(12) Patent Application Publication
(10) Pub. No.: US 2022/0132804 A1
(43) Pub. Date: May 5, 2022

(54) PET TEASER STAND

(71) Applicant: Delca Corp., Laguna Niguel, CA (US)

(72) Inventor: Heather Arnoni, San Clemente, CA (US)

(73) Assignee: Delca Corp., Laguna Niguel, CA (US)

(21) Appl. No.: 17/516,650

(22) Filed: Nov. 1, 2021

Related U.S. Application Data
(60) Provisional application No. 63/108,341, filed on Oct. 31, 2020.

(51) Int. Cl. A01K 15/02

(52) U.S. Cl. CPC A01K 15/025

(57) ABSTRACT

The present invention is a pet teaser stand. The pet teaser stand includes a suction cup base capable of being used on variety of surfaces, a connector tube capable of holding different sized diameter pet teaser wands, and an upright teaser tube capable of holding different sized diameter pet teaser wands. The connector tube connects the upright teaser tube to the suction cup base. The suction cup base allows the pet teaser stand to attach to a variety of surfaces and the upright teaser tube paired with the connector tube provides gripping teeth to hold pet teaser wands. The gripping teeth have a set elasticity allowing the gripping teeth to bend and accommodate different sized diameter pet teaser wands. The upright teaser tube provides the capability to securely hold larger diameter pet teaser wands and the connector tube provides the capability to hold smaller diameter pet teaser wands.

### FIELD OF INVENTION

The present invention relates generally to pet toys. The present invention relates particularly, though not exclusively, to a pet toy stand. The present invention relates more particularly, though not exclusively, to a cat teaser stand. The present application claims priority to Provisional Patent Application No. 63/108,341 filed on Oct. 31, 2020.

### BACKGROUND OF THE INVENTION

Keeping pets active and engaged promotes their growth and development. By playing and interacting with pets it helps with their motor and cognitive development. Physically interactive games like chase and fetch motivate pets to practice their physical skills. Providing mentally challenging puzzles stimulates a cat's brain by coercing it to think of solutions. By playing and interacting with pets, their muscles and their brains are exercised. Unfortunately, human interaction is not always available for pets, but the need for stimulation for pets never disappears.

Pet owners are often preoccupied with daily life, such as going to work, running errands, or otherwise performing essential functions and cannot always provide the stimulation the pets need. As a replacement for human interaction, pet toys offer the stimulation that pets need to keep them active and engaged. Various types of pet toys are available, such as chew toys, puzzle feeders, and teasers. However, once the pet toy is damaged, the entire pet toy must be discarded. Additionally, the pet toy may only be on a particular surface. Moreover, the pet toy may only be used in a particular manner.

In light of the above, it would be advantageous to provide a pet toy capable of replacing a damaged component. It would further be advantageous to provide a pet toy capable of being used on multiple types of surfaces. It would further be advantageous to provide a pet toy capable of being using in multiple different manners.

### SUMMARY OF INVENTION

The present invention is a Pet Teaser Stand to hold a pet teaser wand. The Pet Teaser Stand includes an upright teaser tube removably attached to a suction cup base with a connector tube. The upright teaser tube fits over the connector tube and a portion of the suction cup base. The upright teaser tube in conjunction with the connector tube provides the capability for the Pet Teaser Stand to securely hold the pet teaser wand. The larger diameter of the upright teaser tube has the capability to accommodate large diameters while the smaller diameter connector tube has the capability to accommodate small diameters. The suction cup base is capable attaching to a variety of surfaces.

The Pet Teaser Stand is capable of holding different sized diameter pet teaser wands and attaching it to a variety of surfaces. The Pet Teaser Stand rigidly holds the pet teaser wand to the surface, but has an elasticity to allow the Pet Teaser Stand to flex and bend while returning to its original position. When a pet interacts with the pet teaser wand by hitting, pulling, or tugging on the pet teaser wand, the elasticity of the Pet Teaser Stand provides a reactionary force. This in turn provides interaction for the pet while playing with the pet teaser wand. In addition, the elasticity of the Pet Teaser Stand increases its durability as a pet continually interacts with the pet teaser wand. As the pet teaser wand is damaged by continued use, it may be replaced with a new one. The durability of the Pet Teaser Stand 10 allows it to be used with multiple replacement pet teaser wands.

In addition, the Pet Teaser Stand can be attached to a variety of different surfaces in different orientations to provide additional methods of stimulation for pets. The Pet Teaser Stand may be stood in an upright position. In addition, the Pet Teaser Stand may be attached under a table for an upside-down orientation, attached to a wall or window for a horizontal position, or attached to an angled surface for an angled position. The Pet Teaser Stand may be attached on the floor, low on a table, or high on a wall. By constantly changing the orientation and the height of the Pet Teaser Stand with the attached pet teaser wand, it provides mentally challenging puzzles that stimulates a cat's brain by coercing it to think of different solutions. By interacting with pets using the Pet Teaser Stand and pet teaser wand, their muscles and their brains are exercised without the need for constant human interaction.

### BRIEF DESCRIPTION OF THE FIGURES

The objects, features, and advantages of the invention will be more clearly perceived from the following detailed description, when read in conjunction with the accompanying drawing, in which:

FIG. 1 is a perspective view of a Pet Teaser Stand of the present invention holding a pet teaser wand;

FIG. 2 is a top view of the Pet Teaser Stand;

FIG. 3 is a bottom view of the Pet Teaser Stand;

FIG. 4 is a side view of an upright teaser tube of the Pet Teaser Stand;

FIG. 5 is a side view of the upright teaser tube of the Pet Teaser Stand;

FIG. 6 is a front view of the upright teaser tube of the Pet Teaser Stand;

FIG. 7 is a back view of the upright teaser tube of the Pet Teaser Stand;

FIG. 8 is a top view of the upright teaser tube of the Pet Teaser Stand;

FIG. 9 is a bottom view of the upright teaser tube of the Pet Teaser Stand;

FIG. 10 is a close up view of a gripping tooth of the upright teaser tube of the Pet Teaser Stand;

FIG. 11 is a side view of a connector tube of the Pet Teaser Stand;

FIG. 12 is a front view of the connector tube;

FIG. 13 is a top view of the connector tube;

FIG. 14 is a bottom view of the connector tube;

FIG. 15 is a closed up view of a connector tube gripping teeth of the connector tube;

FIG. 16 is a side view of a suction cup base of the Pet Teaser Stand;

FIG. 17 is a side view of the suction cup base;

FIG. 18 is a front view of the suction cup base;

FIG. 19 is a back view of the suction cup base;

FIG. 20 is a top perspective view of the suction cup base;

FIG. 21 is a bottom view of the suction cup base;

FIG. 22 is an exploded view of the Pet Teaser Stand showing the upright teaser tube, the connector tube, and the suction cup base;

FIG. 23 is a perspective view of the connector tube attached to the suction cup base;

FIG. 24 is a cut-away view of the Pet Teaser Stand showing the upright teaser tube, the connector tube, and the suction cup base; and

FIG. 25 is an alternative embodiment of the upright teaser tube.

### DETAILED DESCRIPTION OF THE INVENTION

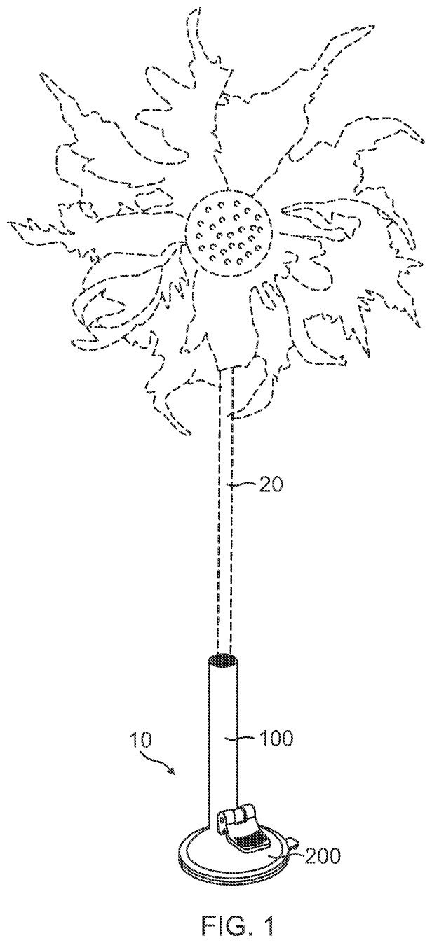

Referring initially to FIG. 1, a perspective view of the present invention, a Pet Teaser Stand, is shown and generally designated 10. The Pet Teaser Stand 10 is capable of holding different sized diameter pet teaser wands 20 and attaching it to a variety of surfaces. The Pet Teaser Stand 10 rigidly holds the pet teaser wand 20 to the surface, but has an elasticity to allow the Pet Teaser Stand 10 to flex and bend while returning to its original position. When a pet interacts with the pet teaser wand 20 by hitting, pulling, or tugging on the pet teaser wand 20, the elasticity of the Pet Teaser Stand 10 provides a reactionary force. This in turn provides interaction for the pet while it plays with the pet teaser wand 20. In addition, the elasticity of the Pet Teaser Stand 10 increases its durability as a pet continually interacts with the pet teaser wand 20. As the pet teaser wand 20 is damaged by use, it may be replaced with a new one. Additionally, the pet teaser wand may have a variety of toys attached to it such as a flower as shown, or, for example, a mouse or feather. Depending on the cat's preference, different pet teaser wands can be used. The durability of the Pet Teaser Stand 10 allows it to be used with multiple replacement pet teaser wands.

In addition, the Pet Teaser Stand 10 can be attached to a variety of different surfaces in different orientations to provide additional methods of stimulation for pets. The Pet Teaser Stand 10 may be stood in an upright position as shown in FIG. 1. In addition, the Pet Teaser Stand 10 may be attached under a table for an upside-down orientation, attached to a wall or window for a horizontal position, or attached to an angled surface for an angled position. The Pet Teaser Stand 10 may be attached on the floor, low on a table, or high on a wall. By constantly changing the orientation and the height of the Pet Teaser Stand 10 with the attached pet teaser wand 20, it provides mentally challenging puzzles that stimulates a cat's brain by coercing it to think of different solutions. By interacting with pets using the Pet Teaser Stand 10 and pet teaser wand 20, their muscles and their brains are exercised without the need for constant human interaction.

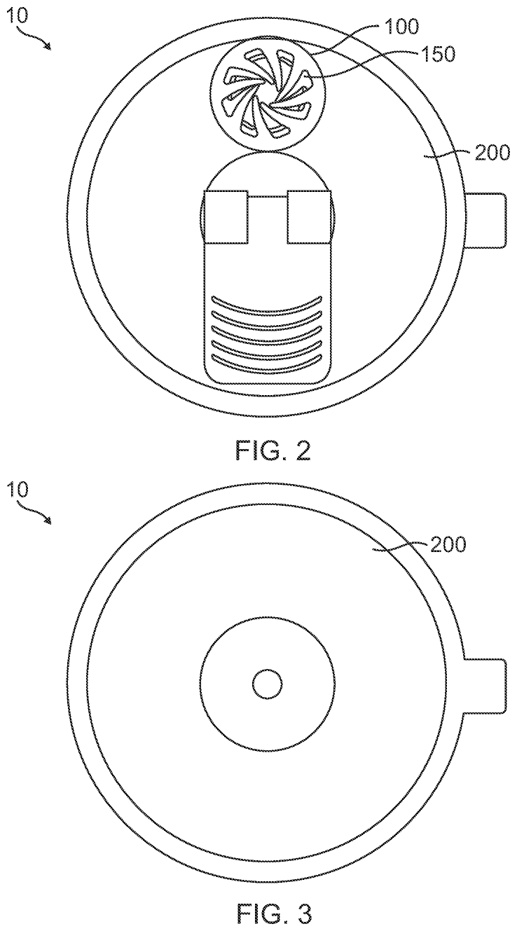

The Pet Teaser Stand 10, described in conjunction with FIGS. 2 and 3, includes an upright teaser tube 100 removably attached to a suction cup base 200 with a connector tube 150 (also shown in FIG. 11). The upright teaser tube 100 fits over the connector tube 150 and a portion of the suction cup base 200. The upright teaser tube 100 in conjunction with the connector tube 150 provides the capability for the Pet Teaser Stand 10 to securely hold the pet teaser wand 10. The larger diameter of the upright teaser tube 100 has the capability to accommodate large diameters while the smaller diameter connector tube 150 has the capability to accommodate small diameters. The suction cup base 200 is capable attaching to a variety of surfaces.

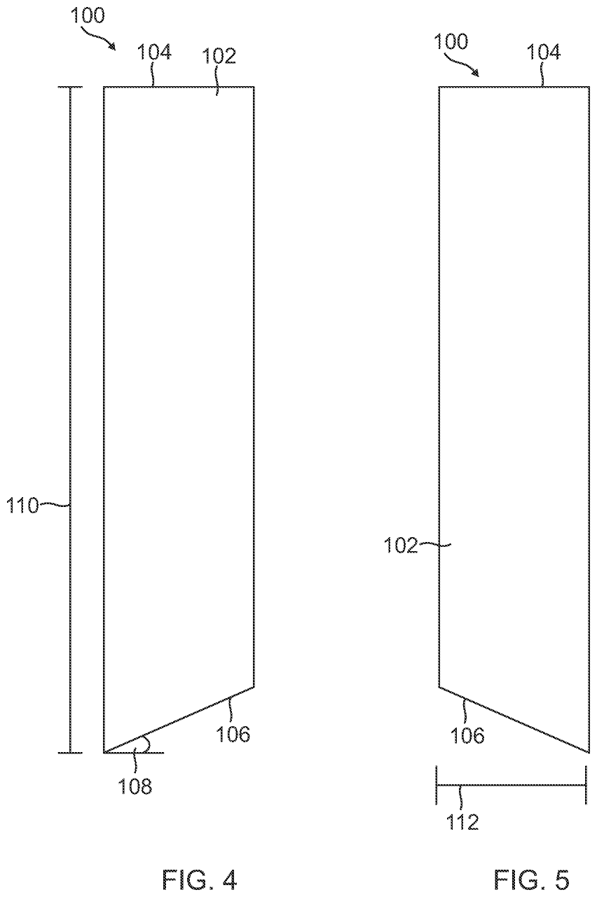

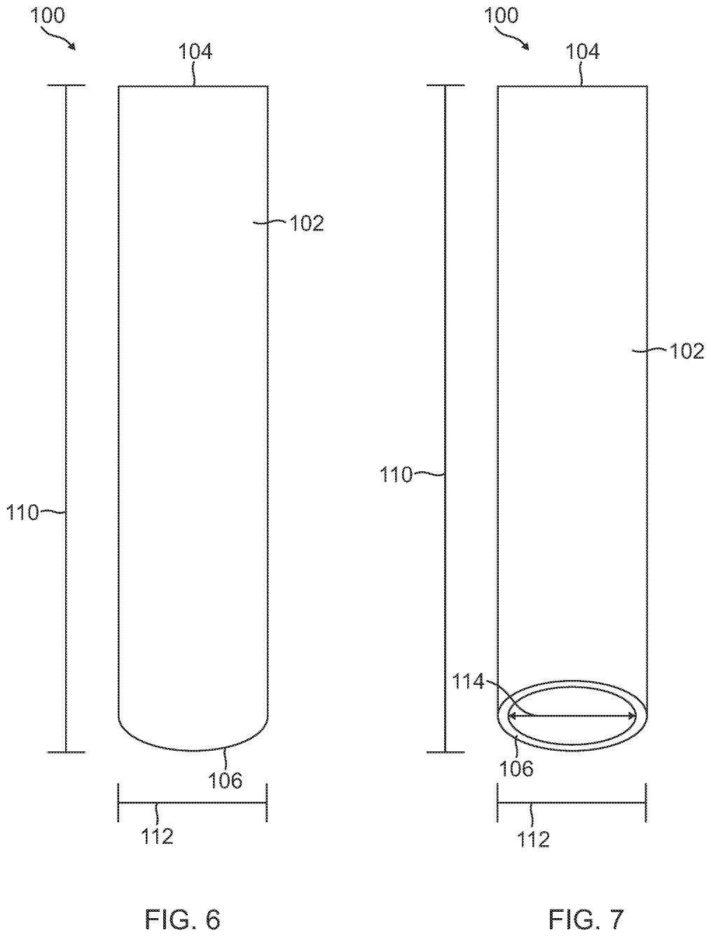

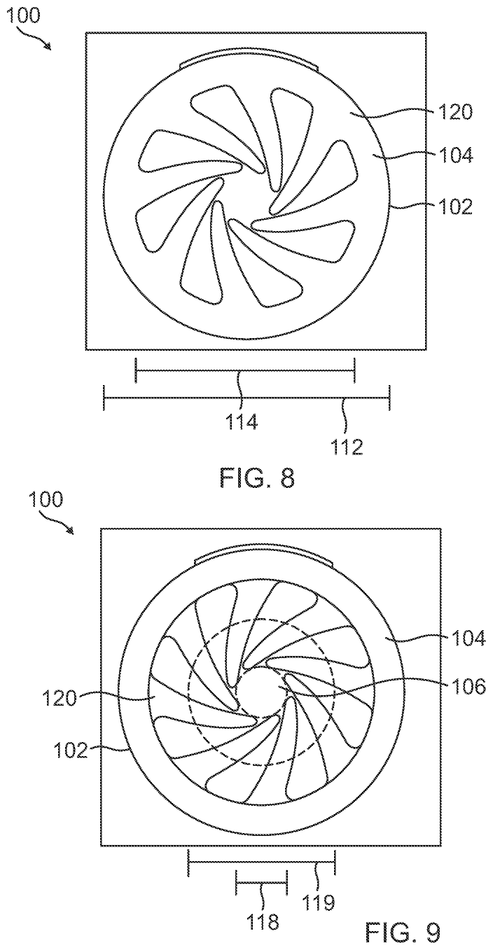

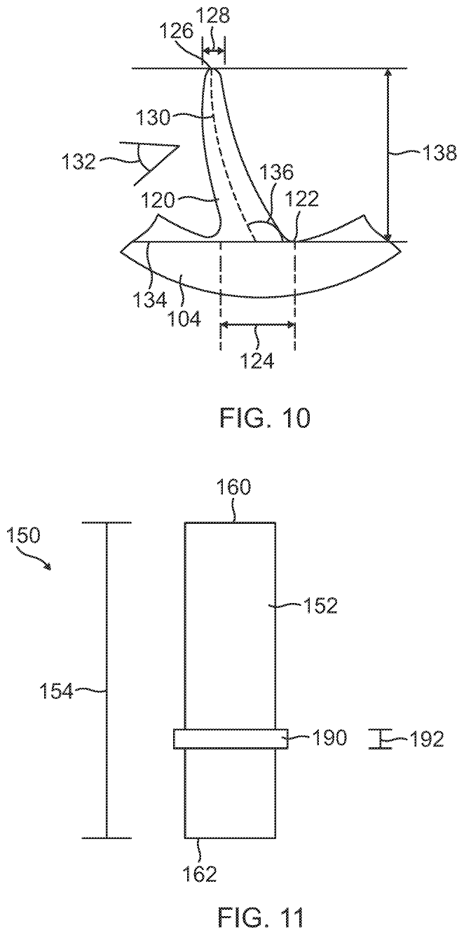

The upright teaser tube 100, described in conjunction with FIGS. 4-10, includes a tubular body 102 with an open top end 104 and an open bottom end 106. The tubular body 102 has a length 110, an exterior diameter 112 and an interior diameter 114. The open top end 104 is straight whereas the open bottom end 106 is shaped to accommodate the outer surface of the suction cup base. In the preferred embodiment, the upright teaser tube 100 is made of thermoplastic rubber (TPR); the TPR material is flexible, durable, and weather and chemical resistant. As result, the upright teaser tube 100 has the flexibility to provide the appropriate reactive force when bent or flexed by a pet, the durability to withstand the rigors of continual use, and resistance to the environment of pet use. The durability of the upright teaser tube 100 allows it to be used with multiple replacement pet teaser wands. Moreover, if the upright teaser tube 100 is damaged it may also be easily replaced.

In the preferred embodiment of the upright teaser tube 100 the open bottom end 106 is formed at an angle 108 and the open top end 106 has a plurality of gripping teeth 120 extending inward from the interior surface of the tubular body 102. A total of eight gripping teeth 120 extend inward from the interior surface of the tubular body 102 leaving an opening 116 with a minimum diameter 118 that may be enlarged to a maximum diameter 119. The gripping teeth 120 have elastic properties to allow the gripping teeth 120 to flex and bend, thereby enlarging the opening 116. The opening 116 provided by the gripping teeth 120 allows a pet teaser wand 20 to be inserted and for the gripping teeth 120 to hold it in place. The elasticity of the gripping teeth 120 allows each of the gripping teeth 120 to flex and bend to enlarge the opening 116 and accommodate pet teaser wand 20 with larger diameters; due to being bent the gripping teeth 120 provides a counteractive force on the pet teaser wand 20 and increases the friction force to hold it in place.

Each of the eight gripping teeth 120 are substantially similar, therefore the description of one of the eight gripping teeth 120 is applicable to all of the gripping teeth 120. The gripping teeth120 includes a base 122 with a thickness 124 and a rounded tip 126 with a diameter 128. A centerline 130 with centerline curvature angle 132 extends from the base 122 to the rounded tip 126 and is generally centered throughout the gripping teeth 120. The centerline 130 is centered at the base 122 and longitudinally projecting through the gripping teeth 120 and centered at the rounded tip 126, thus providing a general curvature to the gripping teeth 120 almost equal to the centerline curvature angle 132; the change in thickness of the gripping teeth 120 from the base 122 to the tip 126 changes the curvature slightly. The total length of the gripping teeth 120 is defined by the length of the centerline 130. The centerline 130 is at a gripping teeth angle 136 from a tangent line 134 though the point of contact of the centerline 130 with the interior surface of the tubular body 102.

The gripping teeth 120 are made of a material with a certain degree of elasticity, which is related to the materials Young's modulus, which is also referred to as the modulus of elasticity. Young's modulus is defined by the ratio of tensile stress to the extension of strain; the value of Young's modulus indicates the resistance of material to reversible longitudinal deformation. In a preferred embodiment of the present invention, the gripping teeth 120 are made of TPR. The material's Young's modulus, the dimensions of the gripping teeth 120, and the orientation of the gripping teeth 120 relative to the interior surface of the tubular body 120 affects the friction force capable of being generated by the gripping teeth 120 and the minimum diameter 118 and maximum diameter 119 of the opening 116. A gripping teeth distance 138, the distance between the tangent line 134 and the rounded tip 126, is also a factor in the minimum diameter 118 of the opening 116. As a result of being thinner near the rounded tip 126 and thicker at the base 122, the gripping teeth 120 are able to more easily flex near the rounded tip 126 than the base 122.

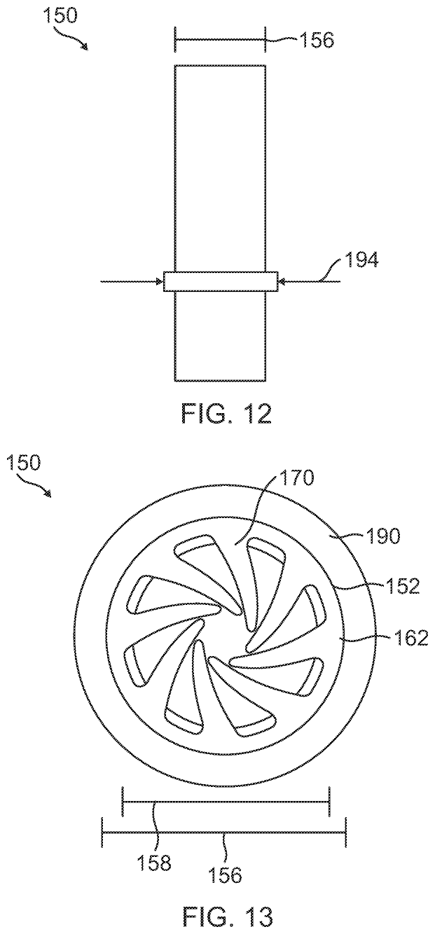

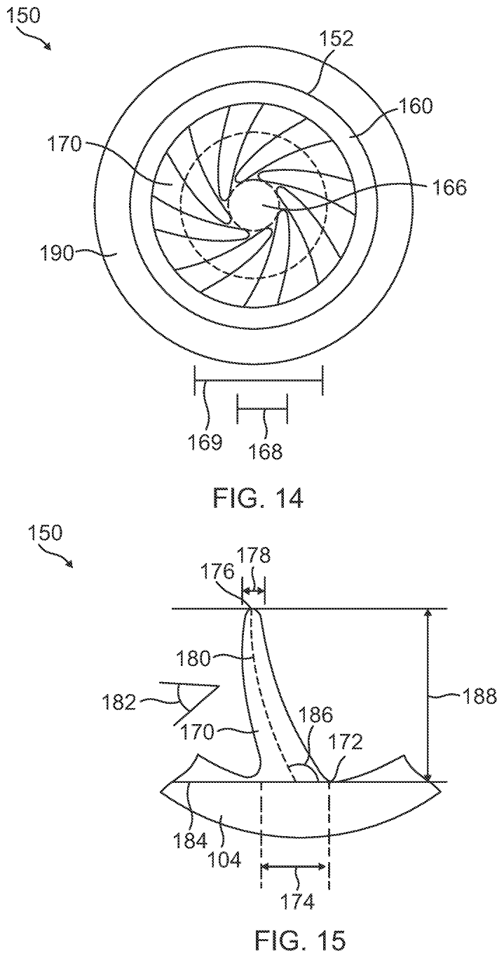

The connector tube 150, described in conjunction with FIGS. 11-15, includes a tubular body 152 with a length 154 an exterior diameter 156, and an interior diameter 158. The tubular body 152 has an open top end 160 and a bottom open end 162. Formed on the exterior surface of the tubular body 152 is a ring 190 with thickness 192 and diameter 194. The exterior diameter 156 of the connector tube 150 and diameter 194 of the ring 190 is smaller than the interior diameter 114 of the upright teaser tube 100 to allow the upright teaser tube 100 to fit over the connector tube 150. Similar to the upright teaser tube 100, the connector tube 150 is formed with connector tube gripping teeth 170. A total of six connector tube gripping teeth 170 extend inward from the interior surface of the tubular body 152 leaving an opening 166 with a minimum diameter 168 that may be enlarged to a maximum diameter 169. The minimum diameter 168 of the opening 166 is smaller than the diameter 118 of the opening 116 and the maximum diameter 169 of the opening 166 is smaller than the maximum diameter 119 of the opening 116.

Each of the six connector tube gripping teeth 170 are substantially similar, therefore the description of one of the six connector tube gripping teeth 170 is applicable to all of the connector tube gripping teeth 170. The connector tube gripping teeth 170 includes a base 172 with a thickness 174 and a rounded tip 176 with a diameter 178. A centerline 180 with centerline curvature angle 182 extends from the base 172 to the rounded tip 176 and is generally centered throughout the connector tube gripping teeth 170. The centerline 180 is centered at the base 172 and longitudinally projecting through the connector tube gripping teeth 170 and centered at the rounded tip 176, thus providing a general curvature to the connector tube gripping teeth 170 almost equal to the centerline curvature angle 182; the change in thickness of the connector tube gripping teeth 170 from the base 162 to the tip 166 changes the curvature slightly. The total length of the connector tube gripping teeth 170 is defined by the length of the centerline 180. The centerline 180 is at a gripping teeth angle 186 from a tangent line 184 though the point of contact of the centerline 180 with the interior surface of the tubular body 152.

The connector tube gripping teeth 170 is made of a material with a certain degree of elasticity. In a preferred embodiment of the present invention, the connector tube gripping teeth 170 are made of TPR. The material's Young's modulus, the dimensions of the connector tube gripping teeth 170, and the orientation of the connector tube gripping teeth 170 relative to the interior surface of the tubular body 152 affects the friction force capable of being generated by the connector tube gripping teeth 170 and the minimum diameter 168 and maximum diameter 169 of the opening 166. A connector tube gripping teeth 170 distance 186, the distance between the tangent line 184 and the rounded tip 176, is also a factor in the minimum diameter 168 of the opening 166. As a result of being thinner near the rounded tip 176 and thicker at the base 172, the connector tube gripping teeth 170 are able to more easily flex near the rounded tip 176 than the base 172.

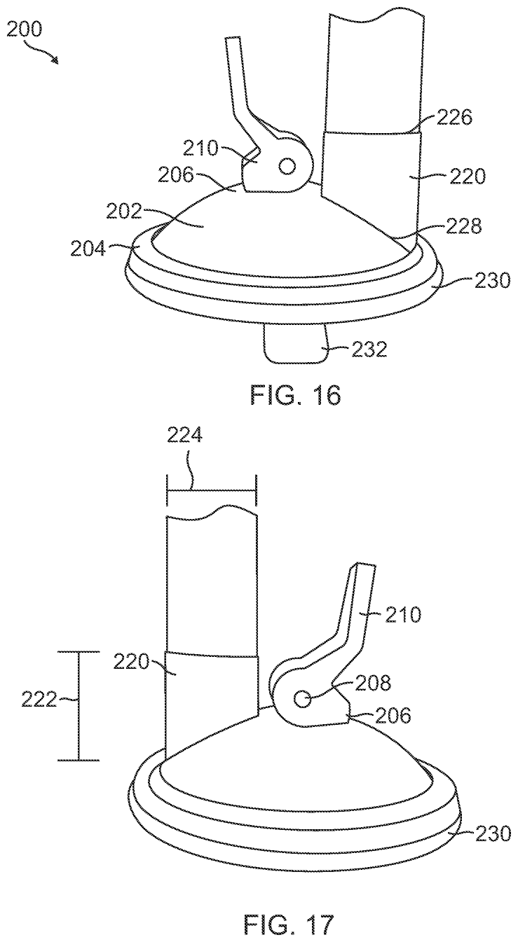

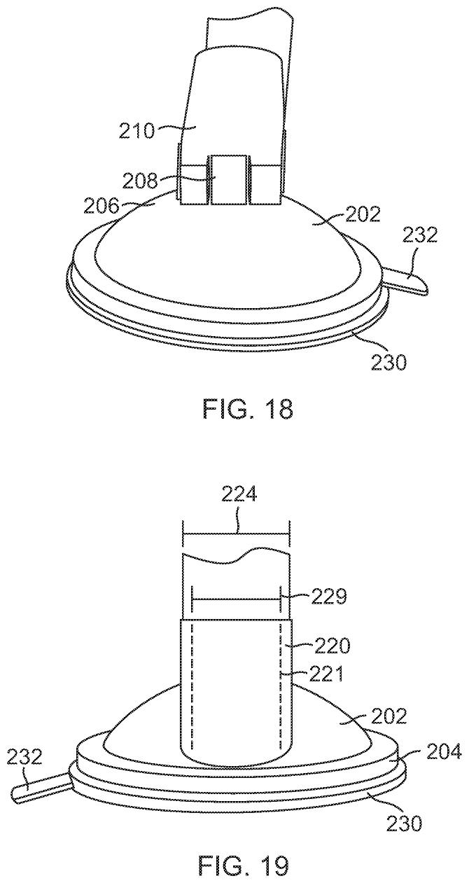

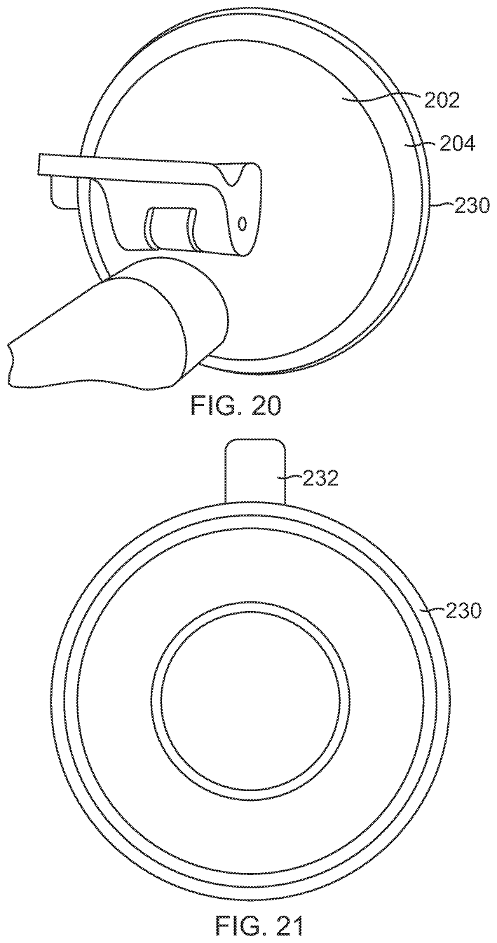

The suction cup base 200, described in conjunction with FIGS. 16-21, includes a domed base 202 with a lip 204 extending outward from the bottom of the domed base 202. The dome base 202 is made of a rigid material to provide stability to the pet teaser stand 10. At the top of the domed base 202 is a plunger surface 206. Extending through the dome base 202 is a plunger 208. At the top edge of the plunger 208 is a lever 210, which, in the preferred embodiment is made of polypropylene. At the opposite end of the plunger 208 is a suction cup 230, which, in the preferred embodiment is made of polyurethane, with a release tab 232, which, in the preferred embodiment is made of polyvinyl chloride. A spring (not shown) is placed on the underside of the dome base 202 between the dome base 202 and the suction cup 230. The lever 210 has an open position and a locking position; the locking position pulls the plunger 208 upward and the open position pushes the plunger 208 downward. By pulling the plunger 208 upward, the attached suction cup 230 is also pulled up which creates a vacuum within the suction cup 230 aiding the suction ability of the suction cup 230. By pushing the plunger 208 down, the vacuum is released and the release tab 232 may be used to remove the suction cup 230 form a surface.

Attached to the dome base 202 is a receiver tube 220. The receiver tube 220 has a length 222 and an exterior diameter 224. The receiver tube 220 is a tube with an internal bore 221 (shown in FIG. 19 in dashed lines) with an interior diameter 229. The receiver tube 220 has an open top end 226 and an open bottom end 228. The open bottom end 228 is formed to match the curvature of the dome base 220. The internal bore 221 is formed to receive the tubular body 152 of the connector tube. The internal diameter 229 of the receiver tube 220 is smaller than the diameter 194 of the ring 190 of the connector tube 150 to prevent the tubular body 152 to slip too far into the internal bore 221. The ring 190 also rests on the open top end 226 to provide additional leverage to the connector tube 150; the leverage helps provide additional rigidity to the upright teaser tube 100 when connected. The exterior diameter 224 of the receiver tube 220 is smaller than the interior diameter 114 of the upright teaser tube 100; the upright teaser tube 100 fits over the connector tube 150 and the receiver tube 220 of the suction cup base 200.

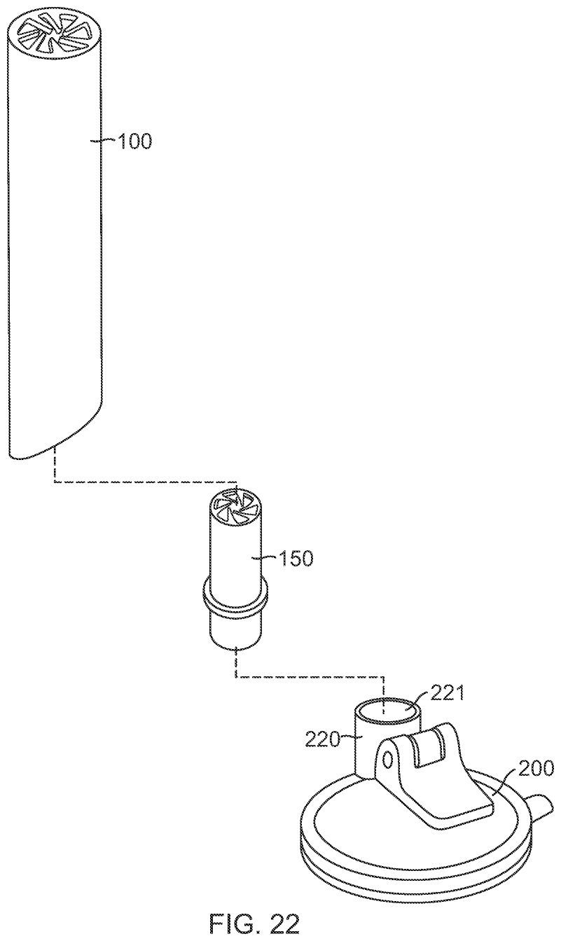

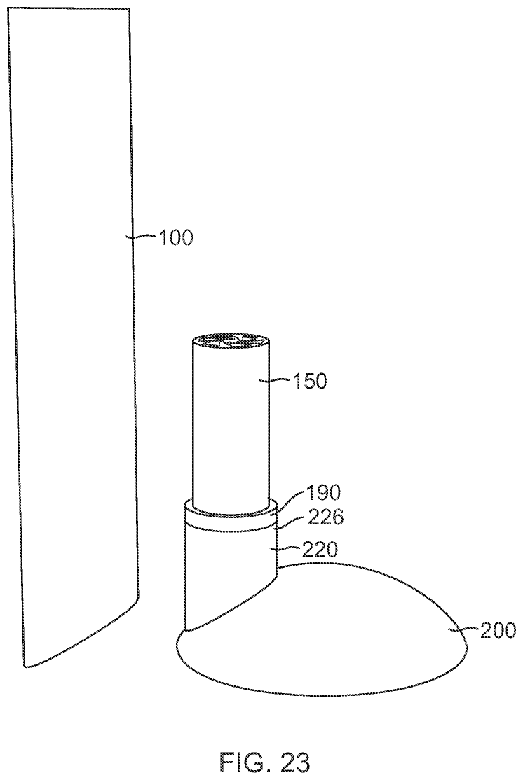

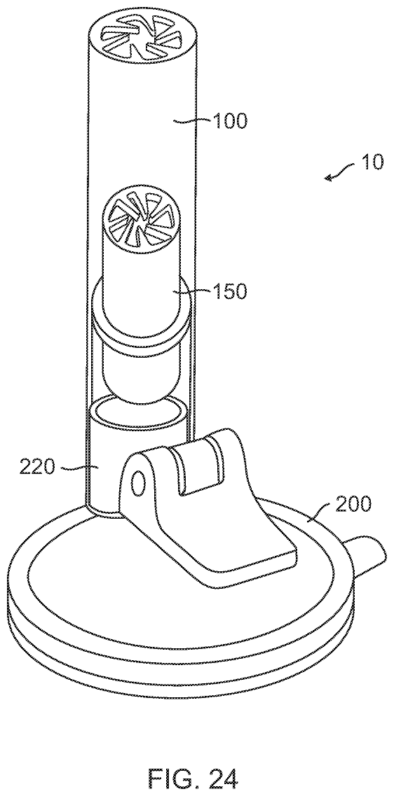

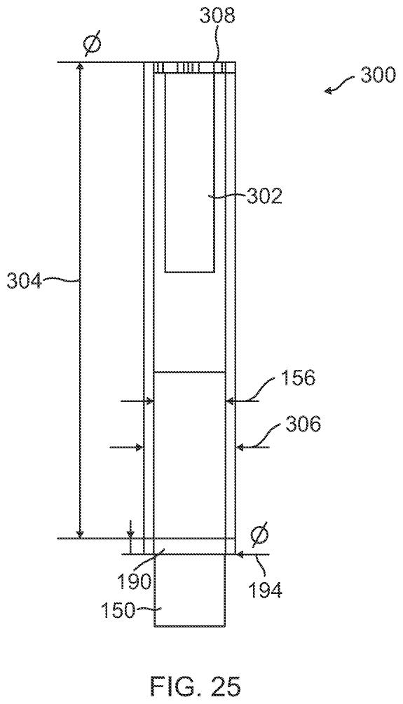

Referring now to FIG. 22, the upright teaser tube 100, the connector tube 150, and the suction cup base 200 are separate pieces of the Pet Teaser Stand 10. The differences in material and form lends to the unique capability of the Pet Teaser Stand 10 to bend and flex to provide an engaging experiencing for a pet. Additionally, by separating the Pet Teaser Stand 10 into each component, a damaged component may be discarded without discarding the entire unit. To assemble the Pet Teaser Stand 10, the connector tube 150 is inserted into the internal bore 221 of the receiving tube 220 of the suction cup base 200. As shown in FIG. 23, the connector tube 150 is inserted into the receiving tube 220 until the ring 190 abuts against the open top end 226 of the receiving tube. After inserting the connector tube 150, the upright teaser tube 100 is then slipped over the connector tube 150 and the receiving tube 220 as shown in FIG. 24.

Referring back to FIG. 1, the Pet Teaser Stand 10 is used to hold a pet teaser wand 20. The Pet Teaser Stand 10 is capable of holding different pet teaser wands 20 with each pet teaser wand 20 capable of having a different diameter stick. By placing the pet teaser wand 20 into the Pet Teaser Stand 10, the gripping teeth 120 of the upright teaser tube 100 and the connector tube gripping teeth 170 of the connector tube 150 grips onto the stick of the pet teaser wand 20 for a secure grip. Additionally, to provide a greater degree of freedom for the pet teaser wand 20 to move when interacting with a pet, the pet teaser wand 20 may be placed only through the gripping teeth 120 of the upright teaser tube 100 and rest on top of the connector tube 150; the gripping teeth 120 will serve as a pivot for the pet teaser wand 20. For larger diameter sticks, the gripping teeth 120 and the connector tube gripping teeth 170 can bend and flex to create a larger opening 116 and 166. For even larger diameter sticks, the pet teaser stand 20 will be unable to go through opening 166 of the connector tube 150 but will instead rest on top of it with the gripping teeth 120 of the upright teaser tube 100 providing the grip to secure the pet teaser wand 20.

Referring now to FIG. 25, an alternative embodiment of the upright teaser tube is shown and generally designated 300. The upright teaser tube 300 is substantially similar to the upright teaser tube 100 except for the interior diameter and exterior diameter. The upright teaser tube 300 has a length 304 equal to length 110, an exterior diameter 306 smaller than exterior diameter 112, and interior diameter 308 smaller than interior diameter 114. The interior diameter 308 is larger than or equal to exterior diameter 156 of the connector tube 150 to fit the upright teaser tube 300 onto the connector tube 150. The exterior diameter 306 may be equal to the diameter 194 of the ring 190 of the connector tube 150 to provide a smooth transition between the connector tube 150 and the upright teaser tube 300.

While the pet teaser stand of the present invention as herein shown and disclosed in detail is fully capable of obtaining the objects and providing the advantages herein before stated, it is to be understood that it is merely illustrative of embodiments of the invention and that no limitations are intended to the details of construction or design herein shown other than as described in the appended claims.

I claim:

1. A pet teaser stand comprising:
a base having a receiver tube, said receiver tube having an inner and outer diameter;
a connector tube having an inner and outer diameter, said connector tube designed to be removably attached to the receiver tube; and
a teaser tube having an inner and outer diameter, said teaser tube designed to be removably attached to the receiver tube and connector tube.

2. The pet teaser stand of claim 1 wherein the base further comprises a suction cup to removably attach the base to a surface.

3. The pet teaser stand of claim 1 wherein the connector tube further comprises a ring.

4. The pet teaser stand of claim 3 wherein the connector tube ring has an outer diameter equal to the receiver tube outer diameter.

5. The pet teaser stand of claim 1 wherein the teaser tube has an inner diameter equal to the receiver tube outer diameter.

6. The pet teaser stand of claim 1 wherein the connector tube is capable of being inserted into the receiver tube.

7. The pet teaser stand of claim 1 wherein the receiver tube and connector tube are capable of being inserted into the teaser tube.

8. The pet teaser stand of claim 1 wherein the connector tube further comprises gripping teeth.

9. The pet teaser stand of claim 1 wherein the teaser tube further comprises gripping teeth.

10. The pet teaser stand of claim 8 wherein the connector tube gripping teeth rigidly secure a pet teaser wand.

11. The pet teaser stand of claim 9 wherein the teaser tube gripping teeth rigidly secure a pet teaser wand.

12. The pet teaser stand of claim 8 wherein the connector tube gripping teeth are made of thermoplastic rubber.

13. The pet teaser stand of claim 9 wherein the teaser tube gripping teeth are made of thermoplastic rubber.

14. The pet teaser stand of claim 1 wherein the teaser tube is made of thermoplastic rubber.

15. The pet teaser stand of claim 3 wherein the connector tube ring has an outer diameter equal to the teaser tube inner diameter.

16. The pet teaser stand of claim 1 wherein the teaser tube has a proximal and distal end, wherein said ends are non-parallel.
